(19) United States
(12) Patent Application Publication
(10) Pub. No.: US 2003/0057396 A1
(43) Pub. Date: Mar. 27, 2003

(54) Replacement refrigerant for R410A

(76) Inventor: Richard E. Cawley, Tyler, TX (US)

Correspondence Address: William J. Beres - 12-1, The Trane Company, 3600 Pammel Creek Road, La Crosse, WI, 54601, US

(21) Appl. No.: 09/964,175

(22) Filed: Sep. 25, 2001

(51) Int. Cl. C09K 5/00; F25D 1/00

(52) U.S. Cl. 252/67

(57) ABSTRACT

An environmentally more benign refrigerant for replacing refrigerant R410A includes a majority portion of refrigerant R32 and a minority portion of refrigerant R134a, the volumetric capacity of the replacement refrigerant permitting it to be used as a near or exact drop-in replacement for refrigerant R410A in terms of volumetric capacity at typical air conditioning system operating conditions.

### BACKGROUND OF THE INVENTION

The present invention relates to refrigerants for use in air conditioners, heat pumps, refrigeration chillers and the like. With still more particularity, the present invention relates to a drop-in or near drop-in replacement refrigerant for the refrigerant commonly referred to as R410A.

Environmental issues have caused the heating, ventilating, air conditioning and refrigeration industry to conduct extensive research during the past decade by which to replace certain existing refrigerants used in air conditioners, heat pumps, refrigeration chillers and the like with refrigerants that are more environmentally benign. Ideally, natural fluids having both low ozone depletion potential (ODP) and global warming potential (GWP), such as carbon dioxide or hydrocarbons, would be used as refrigerants. To date, however, efficiency and safety issues with respect to such “natural” fluids have generally prevented their use as commercially viable refrigerants.

Initial work in the industry in the late 1980's and early 1990's focused on the then more-pressing issue of ozone depletion and, therefore, a refrigerant's ODP value. Having generally addressed the issue of ozone depletion by identifying and adopting refrigerants lower in ODP, the industry focus has more recently turned to the issue of global warming and a refrigerant's GWP value. While certain of the more recently adopted replacement refrigerants have zero ODP values, some have a relatively high GWP value and have the potential to be improved upon.

For example, the recently adopted replacement refrigerant commonly referred to as R410A, which has zero ODP, is a binary mixture of the hydrofluorocarbon (HFC) refrigerants known as R32 (Methylene Fluoride-CH₂F₂) and R125 (Pentafluoroethane-CHF₂CF₃). The R410A blend has been adopted as a replacement, in certain applications, for the hydrochlorofluorocarbon (HCFC) refrigerant referred to as R22 (Chlorodifluoromethane-CHClF₂). R22 continues to be the most commonly used refrigerant for residential and so-called light commercial air conditioning equipment in the world. In another example, R134a (Tetrafluoroethane-CF₃CH₂F), another now commonly used replacement refrigerant, has zero ODP but a still somewhat high GWP value.

Because of their characteristics when applied in air conditioning systems, the use of R410A and R134a within the industry is for generally different kinds and sizes of equipment. R410A, because of its characteristics, is used in lower capacity residential and so-called light commercial air conditioning applications while R134a is used in certain larger capacity, commercial and industrial applications as well as in refrigeration and automotive applications.

When the industry initially searched for R22 replacements in the early 1990's, mixtures very rich in R134a with a minor portion of R32 were given consideration in an attempt to develop an environmentally more benign refrigerant whose characteristics would allow it to be used as a drop-in or near drop-in replacement for R22. Typical of R32/R134a mixtures tested in seeking a replacement for R22 were mixtures consisting of a large majority concentration of R134a with the remainder of the blend being R32. As that work proceeded, the industry found that the R32/R134a blends suitable for drop-in replacement for R22 were considered slightly flammable. Against that background and for several reasons, R410A was chosen by the industry as the preferred R22 replacement and investments were made and continue to be made by the industry to redesign and re-tool major components, particularly compressors, to accommodate the significantly higher operating pressure and higher volumetric capacity of R410A as compared to R22.

While R410A, like R134a, has zero ODP, its GWP value is a relatively high 2340 (2,340 times the GWP value of carbon dioxide which is the benchmark for GWP values). The GWP value of the R32 constituent of R410A standing alone, however, is a relatively much lower 880. While R32 does exhibit and bring with it certain minor flammability issues, its zero ODP and relatively low GWP value make it a relatively good compromise candidate for use in refrigeration systems from the environmental standpoint and a prospectively better one than R410A. However, while R32 will theoretically work as a replacement for R410A, which is itself, once again, a very recently adopted and still being adopted replacement for R22, the volumetric capacity of R32 is higher than that of R410A. Therefore, the direct replacement of R410A with R32 would require the industry to once again redesign and re-tool, at tremendous time, effort and expense, after having just re-tooled to accommodate the volumetric capacity difference between R22 and its R410A replacement.

Because R410A has a GWP value that is relatively high and because it too may potentially be required to be replaced with still another refrigerant having relatively lower GWP value, the need exists to identify a replacement refrigerant for the relatively newly adopted R410A refrigerant which is generally as benign as R410A from an ODP standpoint, but superior to R410A from a GWP standpoint, which offers generally better overall system efficiencies as applied to air conditioning systems and which generally does not affect compressor displacements and therefore preempts the need for the industry to redesign and re-tool in order to accommodate a change, should it come, from R410A to still another replacement refrigerant having a lower GWP value.

### SUMMARY OF THE INVENTION

It is an object of the present invention to provide a refrigerant which is replacement for and has a lower GWP and higher efficiency than R410A.

It is a still further object of the present invention to provide a replacement refrigerant for R410A which broadly satisfies existing R410A air conditioning system requirements, generally without affecting compressor displacement.

Another object of the present invention is to provide a replacement refrigerant for R410A which is comprised of a blend or range of blends of constituent refrigerants that are themselves and in combination more environmentally benign than R410A and the use of which results in system efficiencies comparable or superior to that of R410A.

It is a still further object of the present invention to provide an environmentally benign replacement refrigerant for R410A which functions as an exact or near-exact drop-in replacement for R410A and which therefore would not cause the industry to have to redesign and to re-tool to accommodate its use.

These and other objects of the present invention, which will be apparent when the following Description of the Preferred Embodiment and attached Drawing Figures are considered, are accomplished by the use of a refrigerant in air conditioning and/or refrigeration systems which is a blend of R32 and R134a where the R32 content of the blend is relatively very high and the R134a content of the blend is relatively very low.

### DESCRIPTION OF THE DRAWING FIGURES

FIG. 1 is a schematic diagram of a typical air conditioning system.

FIG. 2 is a graph of the capacity ratio of refrigerant R410A compared to that of the R32/R134a blend of the present invention for different percentages of R32 in the blend.

FIG. 3 is a graph of compressor head pressure for R410A and for the R32/R134a blend of the present invention as well as a ratio thereof for different percentages of R32 in the blend.

### DESCRIPTION OF THE PREFERRED EMBODIMENT

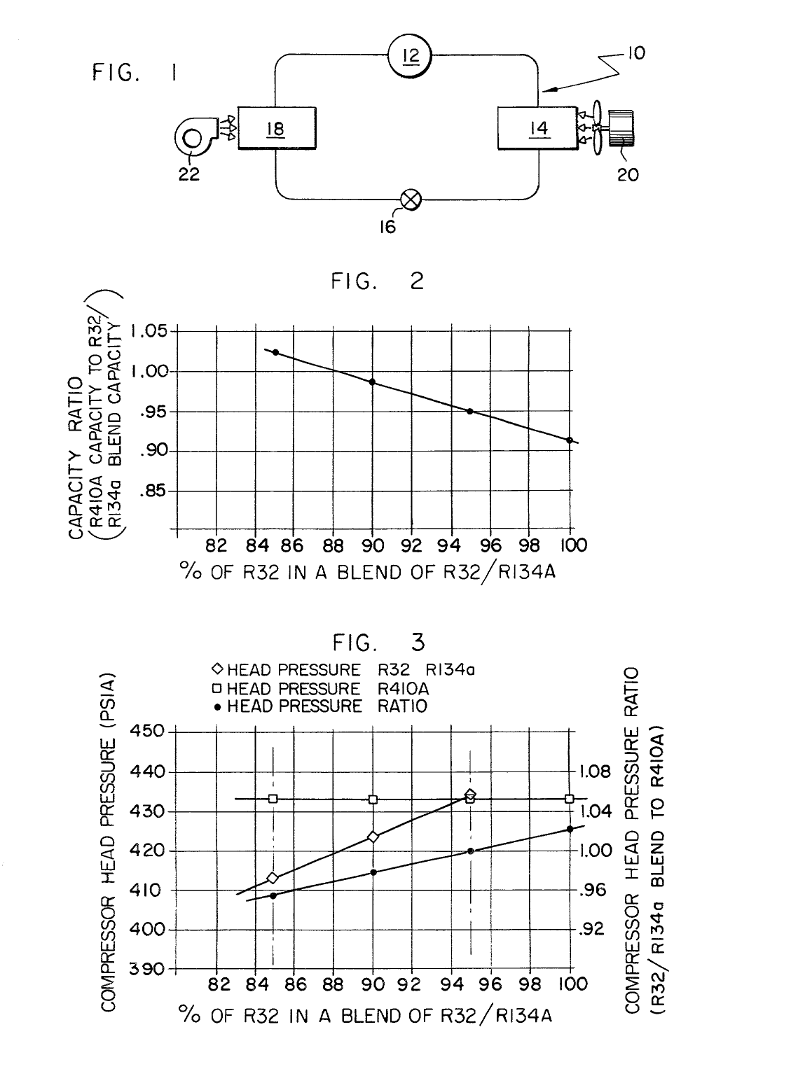

Referring first to FIG. 1, air conditioning system 10 employs a compressor 12, a condenser 14, a refrigerant metering device 16 and an evaporator 18. Those components are most often connected in series to form a refrigeration circuit in which the compressor compresses system refrigerant to a relatively high temperature and pressure and discharges it to the system condenser. The hot, gaseous refrigerant is brought into heat exchange contact with a cooling medium, most typically air or water, in the condenser and condenses to liquid form. In the FIG. 1 embodiment, fan 20 causes outdoor air to flow through condenser 14 so as to cool the refrigerant therein.

The now cooler liquid refrigerant is directed from the system condenser, still at relatively high pressure, to the system metering device. In flowing through the metering device, the pressure of the refrigerant is reduced by the process of expansion which still further cools it. That refrigerant, which for the most part will still be in the liquid state and will now be relatively very cool, flows from the metering device into the system evaporator where it is brought into heat exchange contact with the heat load which it is the purpose of air conditioning system 10 to cool. In the FIG. 1 embodiment, blower 22 causes hot indoor air to flow through evaporator 18, cooling and dehumidifying such air and causing refrigerant in the evaporator to vaporize. The vaporized refrigerant gas is then returned from the evaporator to the system compressor where the process begins anew.

Generally speaking, the design of compressors used in air conditioning systems, in terms of their displacement, is driven by the volumetric capacity of the refrigerant used in the system in which the compressor is employed. Therefore, a change in system refrigerant can, if the replacement refrigerant has a markedly different volumetric capacity than the refrigerant it replaces, require the redesign of the system compressor and/or other system components in order to obtain the same cooling effect of the prior like-sized system. Because most major manufacturers manufacture hundreds of thousands and sometimes millions of compressors and systems per year, the need to retool production lines to accommodate a new refrigerant having a different volumetric capacity necessarily requires a tremendous investment of time, effort and expense.

As has been noted, many systems employing R22 have recently been re-engineered/replaced by systems which employ R410A. While the replacement of R22 with R410A does bring with it certain advantages in terms of the environmental impact of those refrigerants, particularly with respect to their ODP value, the environmental focus on refrigerants is, it is believed, likely to shift from a refrigerant's ODP value to its GWP value.

As was indicated above, R410A, while relatively benign from an ozone depletion standpoint, has a GWP that is quite high and which theoretically can be improved upon. Identification and use of a refrigerant having a lower GWP value to replace the recently adopted (and still being adopted) R410A will preferably involve a refrigerant which does not, generally speaking, affect compressor displacement so as to avoid, to the extent possible, the economic impact of having to redesign and re-tool production lines to accommodate compressor displacement and other system changes.

With that in mind, it has been identified that a blend of R32 with R134a in which the R32 is the major constituent provides a refrigerant with a GWP value significantly better than that of R410A. As importantly, it has been found that such a blend, in proper constituent proportions, is prospectively a drop-in or near-drop-in for R410A having little, if any, effect on compressor displacement.

Referring additionally now to the table of FIGS. 2 and 3, the graphs therein are generated based upon conditions under which a typical central residential or a light commercial air conditioning system operates. Those conditions are as follows: 120° F. average condensing temperature, 45-50° F. evaporator temperature, 15° F. subcooling in the condenser and 20° F. superheat with respect to refrigerant gas returning to the compressor.

As will be apparent from FIGS. 2 and 3, it has been found that when a blend of 95% R32 and 5% R134a is considered, the capacity of R410A is 95% that of the blend and the head pressures resulting from the blend are essentially identical to those of a compressor in which R410A is used. When the percentage of R32 in such a blend is 85%, the capacity is within 2% of that of R410A at head pressures of about 95% that of R410A (412.4 PSIA versus 432.7 for R410A). A blend moreso in the middle of that range, 88% R32 and 12% R134a in particular, yields a near exact drop-in (one-to-one) replacement for R410A from a volumetric capacity standpoint and results in head pressures that are about eight psi less than that of R410A at the specified operating condition.

In sum, a refrigerant blend of R32/R134a where the percentage of R32 in the blend is from 85% to 95% inclusive results in a replacement for R410A that is no more than 5% different, from the volumetric capacity standpoint, than the volumetric capacity of R410A and the use of which results in head pressures consistent with that of R410A. A blend consisting of 88% R32 and 12% R134a results in an exact drop-in replacement for R410A, for the conditions cited, with respect to volumetric capacity, and yields slightly lower head pressures than those that occur when R410A is employed. As such, a replacement has been identified which is an exact or near drop-in replacement for R410A which is significantly more benign from a GWP and efficiency standpoint than R410A yet which prospectively avoids the need for the industry to again redesign and re-tool to accommodate the use of a still newer refrigerant close on the heels of its investment in retooling for the use of R410A to replace R22.

While the present invention has been described in terms of a preferred embodiment, those skilled in the art will recognize that modifications and substitutions therefor, falling within the scope of the invention, can be made. As such, the present invention is limited only in accordance with the language of the claims which follow.

What is claimed is:

1. A refrigeration system comprising:
a compressor;
a condenser;
a metering device;
an evaporator, said evaporator, said compressor, said condenser and said metering device being connected to form a refrigeration circuit; and
a system refrigerant, said system refrigerant being a blend of a first and second other refrigerant, the percentage of said first other refrigerant in said blend being larger than the percentage of said second other refrigerant in said blend and said first refrigerant having a global warming potential value of less than 1000.

2. The refrigeration system according to claim 1 wherein said first other refrigerant is refrigerant R32.

3. The refrigeration system according to claim 2 wherein the percentage of refrigerant R32 in said blend is greater than 85% and wherein said second other refrigerant is R134a.

4. The refrigeration system according to claim 3 wherein the percentage of refrigerant R32 in said blend is less than 95%.

5. The refrigeration system according to claim 4 wherein the percentage of refrigerant R32 in said blend is 88%.

6. A refrigerant blend for use in an air conditioning system comprising:
a blend of refrigerant R32 and refrigerant R134a where the percentage of refrigerant R32 within said blend is greater than 50%.

7. The refrigerant according to claim 6 wherein the percentage of refrigerant R32 within said blend is from 85% to 95% inclusive.

8. The refrigerant according to claim 7 wherein the percentage of refrigerant R32 within said blend is 90% or less.

9. The refrigerant according to claim 8 wherein the percentage of refrigerant R32 within said blend is 88%.

10. A replacement refrigerant for use in an air conditioning compressor the displacement of which is designed for use with refrigerant R410A and which does not necessitate a redesign of the compressor as a result of the difference in volumetric capacity between the replacement refrigerant and refrigerant R410A comprising:
a blend of refrigerant R32 and refrigerant R134a where the majority of said blend is refrigerant R32.

11. The refrigerant according to claim 10 wherein the percentage of refrigerant R32 within said blend is from 85% to 95% inclusive.

12. The refrigerant according to claim 10 wherein the percentage of refrigerant R32 in said blend is 90% or less.

13. The refrigerant according to claim 12 wherein the percentage of refrigerant R32 within said blend is 88%.

14. A blended refrigerant comprising:
a first refrigerant having a global warming potential value of less than 1000; and
a second refrigerant, said blended refrigerant having a volumetric capacity which is generally within 5% of that of refrigerant R410A when used in air conditioning compressors at typical air-cooled air conditioning system operating conditions.

15. The blended refrigerant according to claim 14 wherein said first refrigerant is refrigerant R32, said second refrigerant is refrigerant R134a and wherein the percentage of R32 in said blended refrigerant is greater than the percentage of R134a.

16. The blended refrigerant according to claim 15 wherein the percentage of refrigerant R32 in said blended refrigerant is from 85% to 95% inclusive.

17. The blended refrigerant according to claim 16 wherein the percentage of refrigerant R32 in said blended refrigerant is less than 90%.

18. The blended refrigerant according to claim 17 wherein the percentage of refrigerant R32 in said blended refrigerant is 88%.

19. The blended refrigerant according to claim 14 wherein said second refrigerant is refrigerant R134a and wherein the percentage of said first refrigerant in said blended refrigerant is greater than the percentage of said second refrigerant.

20. The blended refrigerant according to claim 19 wherein said first refrigerant is refrigerant R32 and wherein the percentage of refrigerant R32 in said blend is 95% or less and the percentage of refrigerant R134a in said blend is 5% or more.
